(19) United States
(12) Patent Application Publication
(10) Pub. No.: US 2015/0247770 A1
(43) Pub. Date: Sep. 3, 2015

(54) LANDING LOAD MONITOR FOR CARRIER-BASED AIRCRAFT

(71) Applicant: C. Kirk Nance, Keller, TX (US)

(72) Inventor: C. Kirk Nance, Keller, TX (US)

(21) Appl. No.: 13/847,192

(22) Filed: Mar. 19, 2013

Related U.S. Application Data
(60) Provisional application No. 61/617,109, filed on Mar. 29, 2012.

(51) Int. Cl. G01L 5/16; G01L 5/00; G01P 15/00; B64C 25/68; B64D 45/00

(52) U.S. Cl. CPC G01L 5/16; B64C 25/68; B64D 45/00; G01P 15/00; G01L 5/0052

(57) ABSTRACT

A landing load monitor is used for aircraft during a carrier-type landing event having an arresting cable. The aircraft is provided with a tail-hook assembly that includes a tail-hook and a mounting assembly. The tail-hook is coupled to the aircraft by way of the mounting assembly. A sensor measures the load applied by the tail-hook to the aircraft. A processor is connected to the sensor. The tail-hook loads during a landing event over elapsed time are stored in memory for subsequent retrieval and analysis. The sensor may be located on the tail-hook itself or in the mounting assembly. The aircraft is also provided with inboard and outboard accelerometers on each wing. In addition, the landing gear has pressure sensors to monitor the internal pressure of the landing gear struts. These additional sensors are used during the landing event to monitor the loads on the aircraft. They are also used to identify asymmetrical landings.

This application claims the benefit of provisional application Ser. No. 61/617,109, filed Mar. 29, 2012.

### BACKGROUND OF THE INVENTION

Carrier-based aircraft landings are often considered the most violent of any routine aircraft landing events. The aircraft approaches the sometimes pitching and swaying carrier deck with a high rate of vertical velocity caused by a very steep angle of descent, forcing carrier-based aircraft to hit the carrier deck abruptly, while attempting to “snag” one of the plural steel braided aircraft arresting cables, which are stretched across the landing deck threshold. With typical land-based aircraft landing events, the ground and runway is stationary, where with the aircraft carrier, the deck can sometimes be moving upward at the same time the aircraft is descending towards it. As a result, aircraft landing on carrier decks commonly experience “hard” landings. Hard landings produce high loads on the aircraft.

As carrier-based aircraft make initial touch-down onto the carrier deck, the engines are brought up to full power, in the event all of the arresting cables are missed, thus allowing ample power for the aircraft to abort the landing and resume flight off the other end of the relatively short carrier deck runway. With both aircraft engines at full power, when the arresting cable is snagged, extremely high loads are transferred through the aircraft's tail-hook assembly into the primary center-line airframe structure of the aircraft. This primary center-line airframe structure will be referred to as the “keel” of the aircraft.

Some of the landing loads are absorbed by the aircraft landing gear. The aircraft landing gear struts contain pressurized hydraulic fluid and nitrogen gas. Aircraft landing gear struts incorporate a shock absorbing technique of forcing hydraulic fluid through an internal orifice-hole within a compressible/telescopic strut. The squeezing of the hydraulic oil through the internal orifice-hole allows the fluid friction of that event to dissipate the aircraft's vertical landing loads.

As an aircraft lands, its wings may flex toward the deck. If the landing is asymmetric, where the aircraft lands on one, instead of both, of its main landing gears, then the wing on that side can flex more than the other wing. Carrier based aircraft, such as the F-18 Hornet, have four accelerometers located where the fore and aft sections of the wings attach to the fuselage. These accelerometers monitor changes in acceleration during aircraft launch, throughout the flight, and while the aircraft lands.

Asymmetric landings produce higher than normal loads on the landing gear that is first to touch down.

Carrier-based aircraft are designed to withstand high landing loads. With the exception of the accelerometers provided at the wing-fuselage area, which provides an incomplete data set, aircraft landing loads are not measured. As a result, assumptions are made. It is desirable to measure various vertical and horizontal landing loads experienced by carrier-based aircraft, offering a more accurate means for the comparison of assumed aircraft life limitations, to that of actual aircraft loads which are accurately measured.

Research of the prior art for the measurement of carrier-based aircraft landing loads as measured by the combination and comparison of landing gear strut energy, tail-hook strain loads onto the aircraft keel, and variations of deceleration through inboard and outboard location on the aircraft wing, could not be found. No current US Navy carrier-based aircraft incorporate the patented technology of this inventor for the landing gear strut monitoring technology of U.S. Pat. No. 7,274,309—Aircraft Touch-Down Velocity Monitor, Nance; nor U.S. Pat. No. 7,274,310—Aircraft Landing Gear Kinetic Energy Monitor, Nance.

Additional research of the prior art has found no type of load measuring devices, installed onto the carrier-based aircraft's tail-hook assembly.

Discussions with NAVAIR (Naval Air Systems Command) engineers have verified the use of accelerometers mounted at the F-18 aircraft's wing-root, to measure some but not all of the aircraft wing-loads. The practice for the monitoring of these somewhat limited uses of “wing-root mounted” accelerometers is known, but not found by this inventor, in any published documentation.

### SUMMARY OF THE INVENTION

It is one object of the present invention to provide improvements to this inventor's previous systems for the monitoring of aircraft landing loads (U.S. Pat. No. 7,274,309—Aircraft Touch-Down Velocity Monitor; and U.S. Pat. No. 7,274,310—Aircraft Landing Gear Kinetic Energy Monitor), which utilizes landing gear strut pressure monitoring to measure the vertical sink-speed of the aircraft as it comes into contact with the ground and the landing energy and loads dissipated during each landing event.

It is another object of the present invention to provide a means to extend the “useful-life” of carrier-based aircraft, through the comparison of the aircraft manufacturer's original “fatigue-life assumptions” against the “measured-loads” which the aircraft has, or will actually experience.

It is another object of the present invention to provide a tool to automatically measure the vertical landing loads to the aircraft's airframe, as transferred by each landing gear, when compared with horizontal loads transferred to the aircraft keel through the snagging of the aircraft tail-hook, when further compared to any symmetrical and asymmetrical deceleration experienced by various airframe components, during each landing event.

An apparatus is provided for monitoring an aircraft during a carrier-type landing event having an arresting cable. The apparatus comprises a tail-hook assembly comprising a tail-hook and a mounting assembly. The tail-hook is coupled to the aircraft by way of the mounting assembly. A sensor measures the load applied to the tail-hook to the aircraft. A processor has an input connected to the sensor. The input to the processor, from the sensor can be a direct wired connection, or a wireless transmitted signal from the sensor to the processor. The processor has memory and stores sensor measurements therein. The processor records sensor measurements over elapsed time.

In accordance with one aspect, the sensor is located in the tail-hook mounting assembly.

In accordance with another aspect, the sensor is located on a surface of the tail-hook, which measure loads caused by the stretching of the tail-hook during landing events.

In accordance with still another aspect, the tail-hook comprises an arm, with the sensor located on a surface of the arm.

In accordance with another aspect, the tail-hook mounting assembly has a coupling that rotates about a pin. The sensor is located within the pin.

In accordance with still another aspect, there further comprise inboard and outboard accelerometers located on each wing of the aircraft. The respective inboard accelerometer is located in a portion of the respective wing that attaches to the fuselage of the aircraft and the respective outboard accelerometer is located in the respective tip portion of the respective wing. The accelerometers provide inputs to the processor and the processor stores measurements from the accelerometer over elapsed time during a landing event.

In accordance with still another aspect, the aircraft comprises a landing gear. A pressure sensor is located on each landing gear of the aircraft. The pressure sensors provide inputs to the processor. The processor stores measurements from the pressure sensors over elapsed time during a landing event.

In accordance with still another aspect, the processor further comprises a triggering input, which triggering input initiates the processor to record sensor measurements. A triggering event can be such as the deployment of the landing gear, from within the aircraft fuselage.

In accordance with still another aspect, the processor continually monitors sensor inputs, while the aircraft is in flight. The computer has a software routine with the ability to filter sensor input data, to determine when the sensors are measuring an aircraft landing event. A method of monitoring an aircraft during carrier-type landing events, using an arresting cable, comprises providing a tail-hook coupled to the aircraft frame. The load the tail-hook applies to the aircraft frame over elapsed time as the aircraft lands is measured. The measured loads are stored for subsequent retrieval.

In accordance with one aspect, the measuring of the load the tail-hook applies to the aircraft frame further comprises measuring the load by way of a mounting assembly that couples the tail-hook to the aircraft frame.

In accordance with still another aspect, the step of measuring the load the tail-hook applies to the aircraft frame further comprises measuring the load by way of measuring the stretch of the tail-hook.

In accordance with another aspect, the measuring of the load the tail-hook applies to the aircraft frame begins with a triggering event.

In accordance with still another aspect, the triggering event comprises deployment of the aircraft landing gear from a stowed position.

In accordance with another aspect, assumed aircraft landing loads are provide and the measured loads over plural landing events are compared with the assumed loads.

In accordance with still another aspect, an accelerometer is provided in each one of the wings of the aircraft. The acceleration of the respective wings are measured with the accelerometer and stored for subsequent retrieval.

In accordance with another aspect, acceleration measurements from plural respective accelerometers are stored to allow comparison to other each other.

In accordance with another aspect, a pressure sensor is provided on each landing gear on the aircraft. The pressure sensor measures the internal pressure of the landing gear. The pressure of the landing gear over elapsed time as the aircraft lands is measured and stored.

### BRIEF DESCRIPTION OF THE DRAWINGS

Although the features of this invention, which are considered to be novel, are expressed in the appended claims; further details as to preferred practices and as to the further objects and features thereof may be most readily comprehended through reference to the following description when taken in connection with the accompanying drawings, wherein:

FIG. 1a is a view of a US Navy F-18 Hornet aircraft, flying through the air, with landing gear extended, and tail-hook retracted.

FIG. 1b is a view of a US Navy F-18 Hornet aircraft, landing on an aircraft carrier deck, with tail-hook extended, and snagging a typical arresting cable.

FIG. 2 is a schematic view showing a portion of the tail-hook and mounting assembly.

FIGS. 3a, 3b, 3c, 3d, 3e, 3f show a series of side views of the telescopic elements of a typical trailing arm design, aircraft landing gear strut:
prior to coming into contact with the ground
coming into initial contact with the ground
as the landing gear compresses during the landing event
as compared to Elapsed Time.

FIG. 4 is an overhead view of a US Navy F-18 Hornet aircraft, illustrating multi-axis accelerometers, mounted at inboard and outboard locations of both aircraft wings.

FIG. 5 is a front/nose view of a US Navy F-18 Hornet aircraft, making an asymmetrical landing, illustrating wing deflection with differential points of acceleration.

FIG. 6a is an overhead view of a US Navy F-18 Hornet aircraft, making a typical landing, with symmetrical deceleration loads.

FIG. 6b is an overhead view of a US Navy F-18 Hornet aircraft, making an atypical landing, with asymmetrical deceleration loads.

FIG. 7 is a graph showing the load applied by the tail-hook to the aircraft during a cable arrest.

FIG. 8 is a schematic diagram of the onboard computer, sensor inputs and software programs of the invention.

### DETAILED DESCRIPTION OF THE PREFERRED EMBODIMENT

Carrier-based aircraft typically use landing gear struts which are designed much like, and incorporate many of the features of a typical shock absorber. The landing gear struts dissipate aircraft landing loads. The shock absorber of the landing gear strut comprises internal fluids, of both hydraulic oil and compressed nitrogen gas. The aircraft weight is transferred to and/or identified by the pressures contained within the landing gear struts. Weight is proportional to pressure measured in “psi” (pounds per square inch).

Carrier-based aircraft typically use a tail-hook to snag a steel braided arresting cable, located at the threshold of the landing area, to catch the aircraft as it lands onto the aircraft carrier deck.

The strain/loads experienced by the tail-hook arm and its associated components are monitored. In the preferred embodiment, the strains/loads are measured by the stretch of the tail-hook arm and shear loads at the hinge-pin assembly which attaches the tail-hook arm to the aircraft's keel, and measured at the retaining pin which connects the tail-hook cup to the tail-hook arm. The hinge-pin of the F-18 Hornet mounting assembly is a hollow steel tube/sleeve, designed with a wall thickness suitable to withstand the landing loads of the aircraft. The retaining pin of the tail-hook cup is a solid steel rod, designed with a thickness suitable to withstand the landing loads of the aircraft. This sleeve and or rod can easily be replaced with a properly sized “Clevis Pin Load Cell” such as the Series LDP990 manufactured by STI (Stellar Technology, Inc.) allowing the deflection/yielding of the shaft of the Clevis Pin Load Cell to measure the tail-hook loads, passing to the aircraft keel, as the tail-hook snags the flight deck arresting cable.

Also monitored are the strain/loads experienced through changes in acceleration, both symmetrical and asymmetrical, at various locations on the aircraft wings.

The F-18 Hornet aircraft, which is used as an example in this description, typically use multi-axis accelerometers to measure changes in acceleration at the aircraft's wing-roots. As discussed herein additional multi-axis accelerometers are installed at the wing-tips, to offer a wider range of locations for measurement, thus allowing more accurate acceleration/deceleration data sources.

An automated compilation is performed of the loads applied to various aircraft assemblies and components, those loads being generated by the aircraft landing on a carrier deck.

Also monitored are the amount of pressure changes and the rate of pressure changes to the fluids within each of the landing gear struts, along with the rate of internal volume reduction and the amount of internal volume reduction, caused by the compression of each respective landing gear strut so as to determine the amount of energy dissipated by each respective landing gear strut. These pressure changes are caused by compression of the landing gear struts, during the landing of the aircraft.

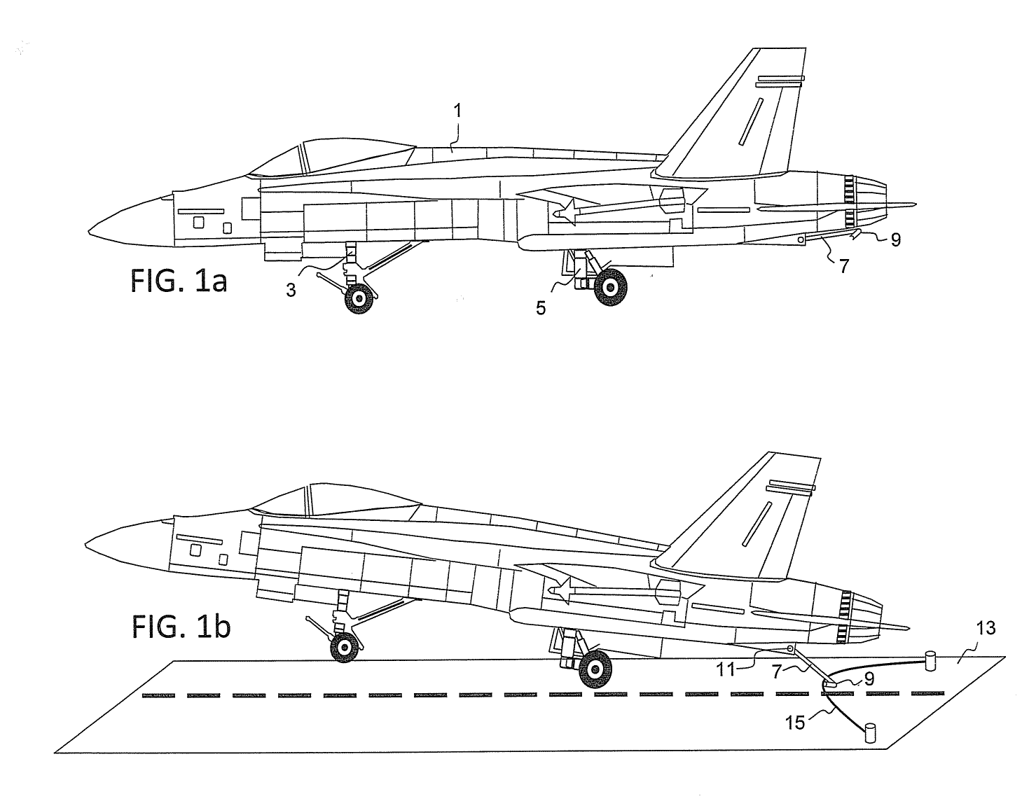

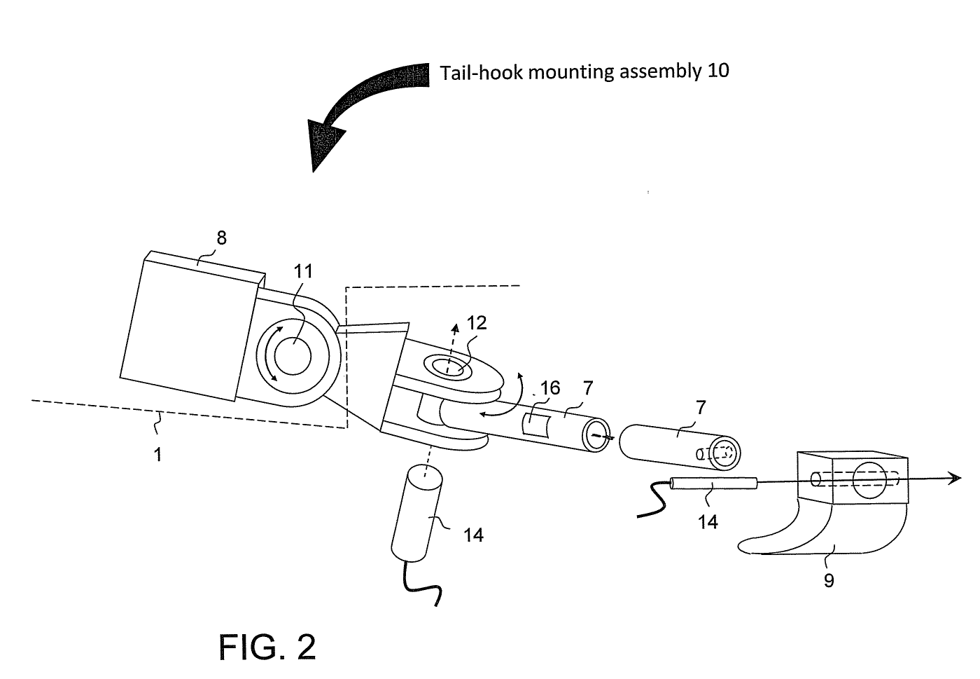

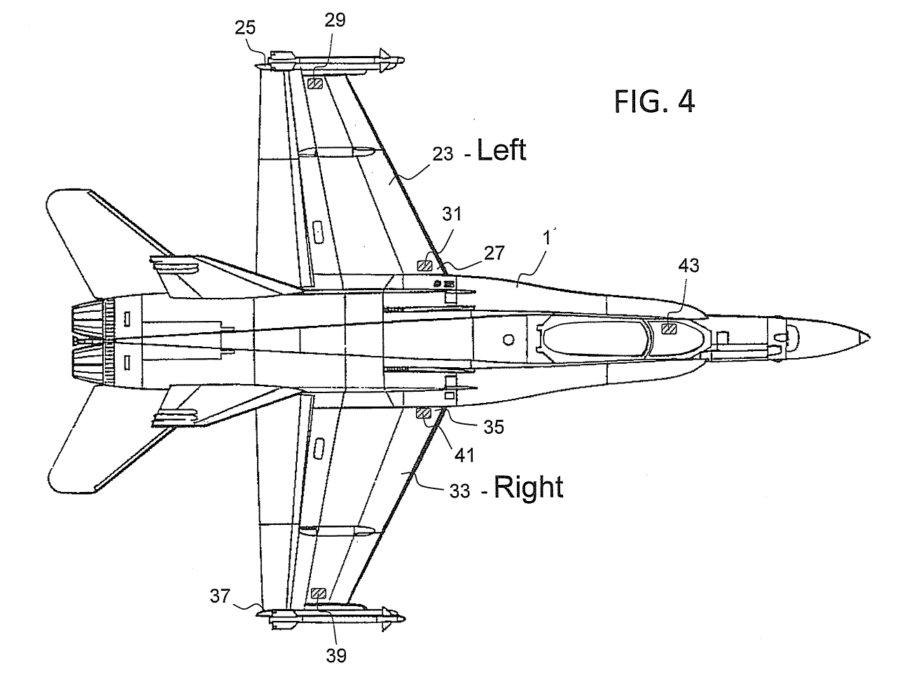

Referring now to the drawings, wherein like reference numerals designate corresponding parts throughout the several views and more particularly to FIG. 1a there is shown a carrier based aircraft, in particular an F-18 Hornet aircraft 1, in flight, with tricycle landing gear configuration consisting of a nose landing gear 3, and shown one of the two identical main landing gear 5. (FIG. 5 shows the other main landing gear 6.) Aircraft 1 also utilizes a tail-hook arm 7 which uses a cup 9 to catch and arrest the aircraft 1 as it lands on an aircraft carrier. Tail-hook arm 7 is in the stowed position in this FIG. 1a.

Referring now to FIG. 1b there is shown aircraft 1 landing onto an aircraft carrier deck 13. Aircraft 1 has tail-hook arm 7 in the deployed position and is attached to aircraft 1 by hinge pin 11, with tail-hook cup 9 snagging a braided steel arresting cable 15, as the aircraft 1 lands into aircraft carrier deck 13.

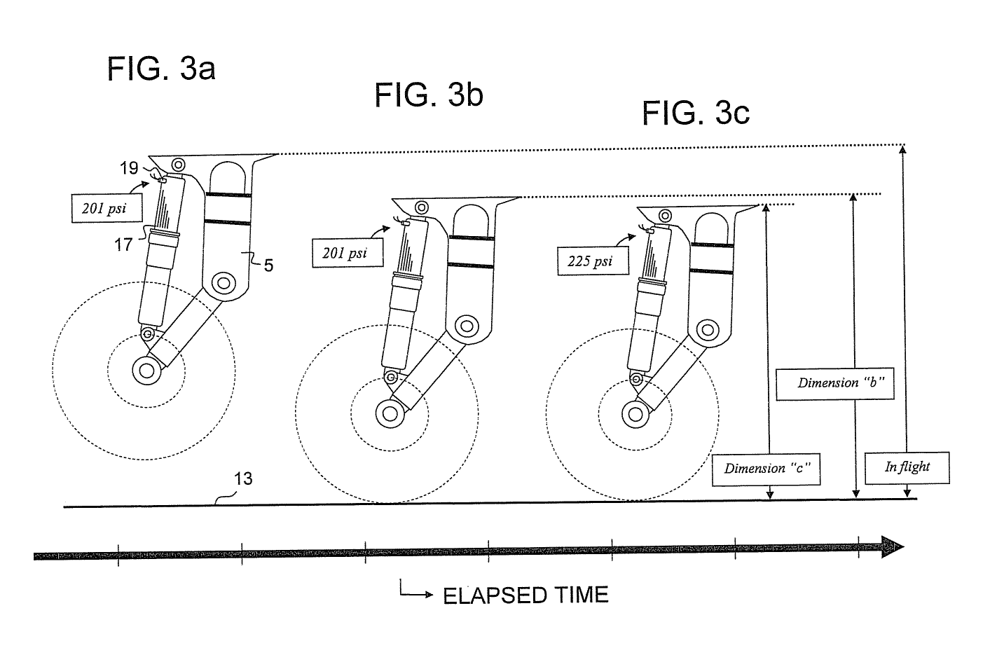

In FIG. 2 there is shown the tail-hook mounting assembly 10 for aircraft 1. The airframe structure of aircraft 1 is illustrated by the dashed line. In the embodiment shown, the tail-hook mounting assembly 10 is a type of universal joint that deploys the tail-hook arm 7 by tail-hook actuator 8, allowing tail-hook 7 to move vertically up and down and horizontally side-to-side. The tail-hook mounting assembly 10 has two hinge-pins 11 and 12. One pin 11 allows the arm 7 to move vertically up and down while the other pin 12 allows the arm 7 to sweep generally horizontally from side to side.

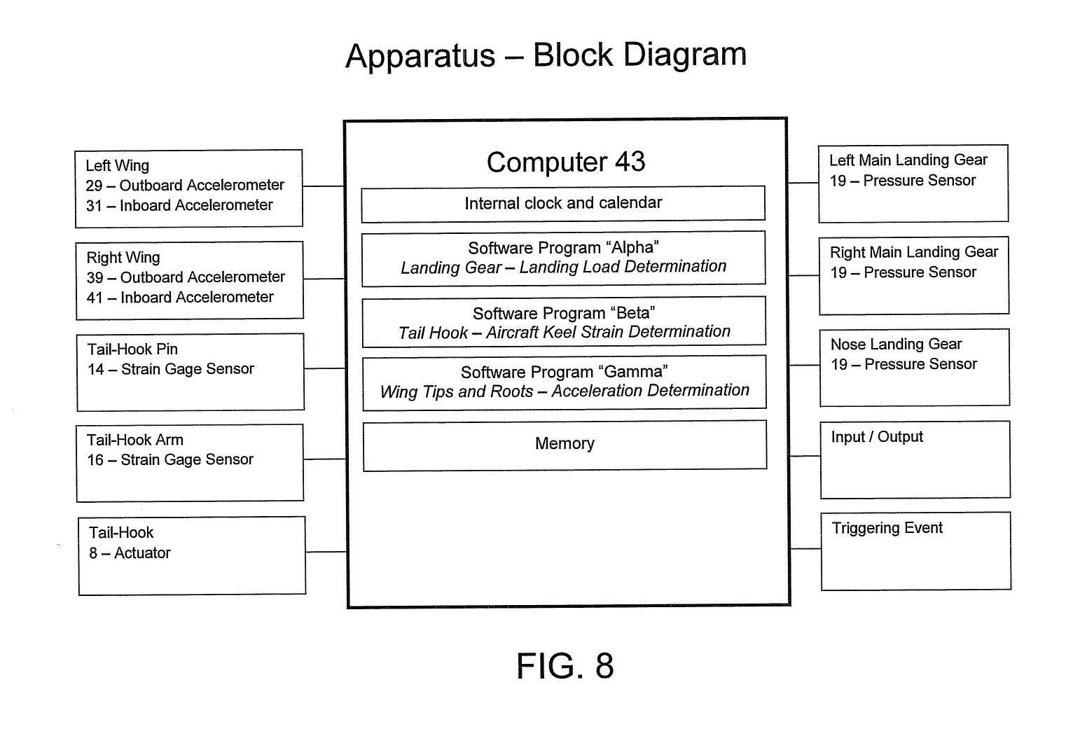

A sensor is provided to measure either the shear load applied to one of the mounting pin assemblies or the stretch load applied to the tail-hook 7. With regard to a mounting pin assembly, one or both of the pins 11 and 12 can be replaced with a load cell pin 14 (which contains a strain gauge), such as the commercially available series LDP990 Clevis Pin Load Cell manufactured by STI (Stellar Technology, Inc.) (other types and variations of load cell pins are available). The other of the pins 11 and 12 may or may not be converted to a load cell pin 14, and may remain as a conventional pin. The load cell pin 14 is provided with a connector. A cable harness connects the load cell pin 14 to a computer 43 (see FIG. 8). The load cell pin 14 may also transmit tail-hook load data, via a wireless signal to computer 43.

Located at the trailing end of arm 7 is tail hook cup 9, which is used to snag the arresting cables. Tail-hook cup 9 slides over the end of arm 7 and is secured to arm 7 with a retaining pin. In the preferred embodiment the removed retaining pin (not shown) is replaced with a load cell pin 14. The load cell pin 14 is provided with a connector. A cable harness connects the load cell pin 14 to a computer 43 (see FIG. 8). The load cell pin 14 may also transmit tail-hook load data, via a wireless signal to computer 43.

Landing loads which are transferred through arm 7 to the keel of the aircraft, will cause arm 7 to stretch. The amount of arm 7 stretch is measured by a surface mounted strain gauge sensor 16. Strain gauge sensor 16 can be mounted to the exterior surface of arm 7, or mounted to the interior surface of arm 7 (not shown). The sensor 16 can be mounted on the hook 9 if such a mounting arrangement would provide accurate measurements. The strain gauge sensor 16 can be connected to a computer 43 by wires running inside of the arm 7. In the alternative, the sensor 16 can be wireless. As a wireless device, the sensor 16 has either a battery or an energy harvester which generates electrical energy from surrounding conditions such as heat (near the engine exhaust) or vibration. While several strain gauges 14, 16 are shown in the drawings for illustration purposes, only one strain gauge need be used.

Tail-hooks can vary in design depending on the aircraft. For example, an F-18 aircraft has a tail-hook with a single rod-like arm 7. Other types of aircraft may have tail-hooks shaped like a “Y”, with the upper brackets of the “Y” connected to the aircraft frame with a “Y” shaped configuration. Each upper branch is connected to mounting structures on the aircraft; each mounting structure has a monitored load cell pin.

Referring now to FIGS. 3a, 3b, 3c, 3d, 3e, and 3f there are shown illustrations of the aircraft landing load identification technologies of U.S. Pat. No. 7,274,309 and U.S. Pat. No. 7,274,310—Nance. The prior art of U.S. Pat. Nos. 7,274,309 and 7,274,310 are shown as examples of one of the load data recording methods which is used as a contributing technology to this new and more broadly applied carrier-based aircraft landing load data acquisition system. As landing gear 5 collapses it dissipates aircraft landing loads. The pressure within telescopic shock absorber strut 17 increases as it collapses. Pressure sensor 19 measures increases in pressure, related to the amount of load generated and dissipated by the aircraft landing event. As shock absorber strut 17 pressure increases from the in-flight pre-charge strut pressure of 201 psi to 225 psi, then 250 psi, then 350 psi and finally to 450 psi. The landing gear strut compresses from an in-flight posture, being full telescopic extension of shock strut 17, to the collapsing postures of Dimensions b, c, d, e, and finally Dimension f. The complete disclosures of U.S. Pat. Nos. 7,274,309 and 7,274,310 are incorporated herein by reference.

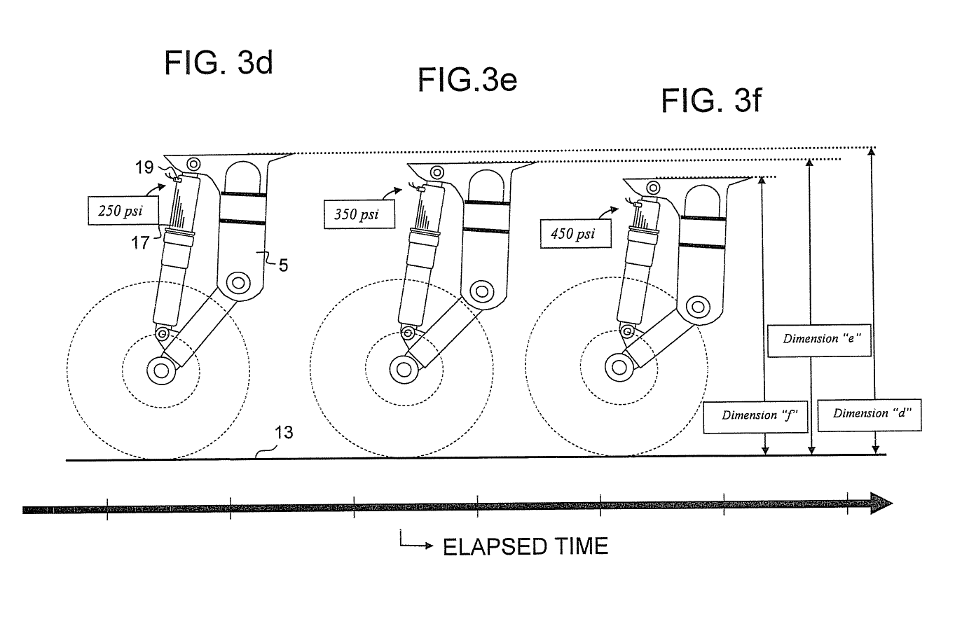

Referring now to FIG. 4, there is shown an overhead view of aircraft 1, with a left wing 23 and a right wing 33. Left wing 23 has an inboard wing location 27 located adjacent to the aircraft 1 fuselage, and an outboard wing location 25 located away from the fuselage at the wing-tip. Similarly there is a right wing 33 inboard location 35 and an outboard location 37. A multi-axis accelerometer 29 is installed at left wing outboard location 25. A multi-axis accelerometer 31 is installed at left wing inboard location 27. A multi-axis accelerometer 41 is installed at right wing inboard location 35. A multi-axis accelerometer 39 is installed at right wing outboard location 37.

Referring now to FIG. 5, there is shown aircraft 1 landing on carrier deck 13 where aircraft 1 has made an asymmetrical landing. As an example, an asymmetrical landing can be illustrated where the tire 51 of main landing gear 5 comes into contact with carrier deck 13 before tire 53 of main landing gear 6. This event will have the full force of the initial landing impact applied to main landing gear 5. As aircraft 1 continues to descend and tire 53 comes into contact with carrier deck 13, main landing gear 6 will begin to absorb and dissipate the remaining vertical landing loads. As a further example, when the vertical landing loads are dissipated, wing 23 can flex, allowing outboard accelerometer 29 to have a lower amount of initial deceleration 47 (acceleration is illustrated by block-arrows [symbol] [symbol] ), when compared to a higher amount of deceleration 45 to inboard accelerometer 31. The recoiling spring action of main gear 5 with the additional spring in tire 51 combined with any flexibility of wing 23 can also allow wing accelerometer 29 to accelerate in an opposite direction 49. Comparison of these different rates and directions of acceleration/deceleration allow for calculations as to the loads experienced by wing 23 where it connects to the fuselage of aircraft 1.

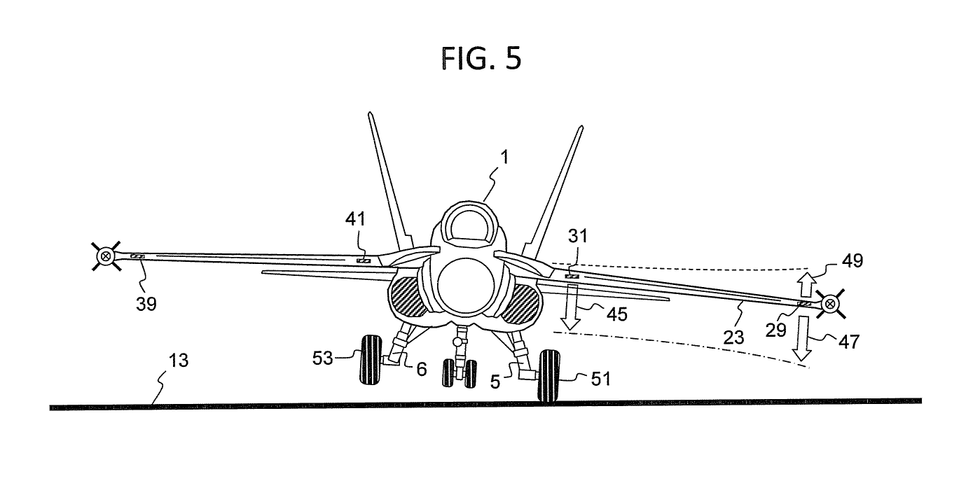

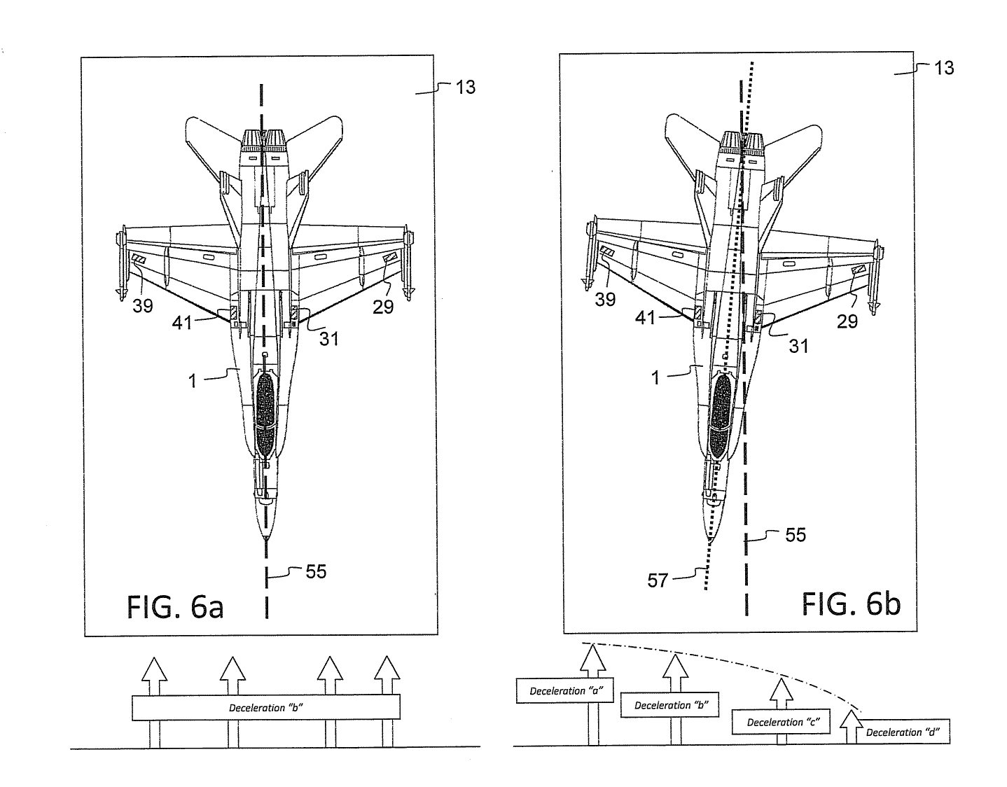

Referring now to FIG. 6a, there is shown an overhead view where aircraft 1 is aligned with and landing parallel to the center-line 55 of carrier deck 13. As aircraft 1 makes a typical carrier deck landing, a sudden deceleration is caused by tail-hook 7 (see FIG. 2) snagging arresting cable 15). Typically aircraft 1 will land on the carrier deck 13, where the aircraft 1 will stop with sudden and symmetrical deceleration, as recorded by all four accelerometers 29, 31, 39, 41 as show by an equal pattern of deceleration “b” (deceleration is illustrated by block-arrows [symbol] ). Comparison of these equal rates of deceleration allow for calculations as to the loads experienced by wing 23 where it connects to the fuselage of aircraft 1.

Referring now to FIG. 6b, there is shown an overhead view of aircraft 1 where the landing of aircraft 1 has resulted in aircraft 1 not being aligned, nor parallel with the center-line 55 of carrier deck 13. There are times where aircraft 1 will have an asymmetrical approach angle 57 to the carrier deck 13 where aircraft 1 will be arrested with asymmetrical deceleration. The loads experienced by the sudden asymmetrical deceleration of aircraft 1 are measured by accelerometers 39, 41, 31, 29 where there is a higher rate of deceleration as illustrated in Deceleration “a” recorded by accelerometer 39, as compared to the lower rate of deceleration illustrated in Deceleration “d” recorded by accelerometer 29. This asymmetrical deceleration is typically caused by “lateral slippage” of tail-hook cup 9 along the stretched arresting cable 15 (see FIG. 2) when the aircraft landing angle is not parallel with the runway. Comparison of these different rates of deceleration allow for calculations of the asymmetrical loads experienced by each wing, where it connects to the fuselage of aircraft 1.

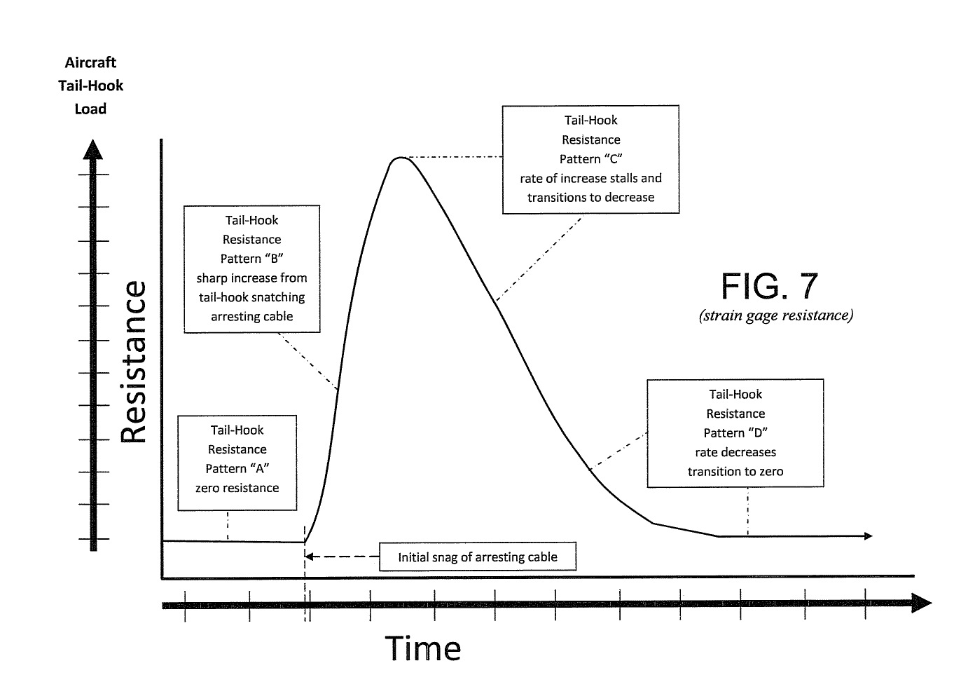

Referring now to FIG. 7 there is shown a graph of the load applied to the aircraft keel/frame, by the tail-hook during an arresting cable capture event. As the aircraft flies and then lands onto the carrier deck, the tail-hook has little or no load as represented by Pattern “A”. When the tail-hook snags the arresting cable, the load sensed by the strain-gauge sensor embodiment of pin 11 increases dramatically, as represented by Pattern “B”. The arresting cable has some stretch to it and load dampening/absorbing capabilities, so that the increased resistance is not instantaneous, but occurs over a short period of time. As the cable stretches and the arresting loads are absorbed, wherein the increased load on the tail-hook stalls and begins to decrease, as represented by Pattern “C”; the aircraft is then brought to a stop, with no loads on the tail-hook, as represented by Pattern “D”.

Referring now to FIG. 8 there is shown an illustration of the onboard computer 43 which receives inputs from landing gear strut pressure sensors 19, the sensor of tail-hook hinge-pin 11, and wing accelerometers 29, 31, 39, 41. The computer has an internal clock and a calendar, memory, as well as input and output ports. Various software programs with algorithms to measure, calculate and record aircraft landing gear loads, tail-hook loads along with airframe and wing deceleration patterns, are contain within computer 43 and herein described:
Software Program “Alpha” Landing Gear—Landing Load Determination, receives inputs from landing gear strut pressure sensors 19, where recognition of changing strut pressure in each respective landing gear strut, and said pressure changes are monitored against elapsed time, to allow for the determination of vertical landing loads of aircraft 1 (see FIG. 2) experienced by each landing gear shock strut
Software Program “Beta” Tail-Hook—Aircraft Keel Strain Determination receives inputs from strain gauge sensors 14 located inside the aircraft tail-hook hinge pin (11 or 12), mounting assembly for tail-hook cup 9, and strain gauge sensor 16 located on the surface of tail-hook arm 7, where recognition of changing amounts of strain experienced by the tail-hook arm and mounting pins, as the tail-hook snags the arresting cable 15 (see FIG. 2) to allow for determination of horizontal landing loads which are transferred to the primary keel structure of the airframe.
Software Program “Gamma” Wing-Tips and Roots—Acceleration Determination receives inputs from the various multi-axis accelerometers 29, 31, 39, 41 mounted inside of both inboard and outboard locations of the aircraft wings. The locations of the plural accelerometers allow for better determination of vertical and horizontal loads experienced by the aircraft wings and aircraft fuselage, with variation in both symmetrical and asymmetrical deceleration patterns.

In operation, as the aircraft approaches the aircraft carrier flight deck, it deploys its landing gear and tail-hook as shown in FIG. 2. The tail-hook is provided with an actuator 8 (see FIG. 2), typically hydraulically or electrically operated to raise and lower the tail-hook arm 7. The computer 43 can be signaled to start recording data from the sensors 14, 16, 19, 29, 31, 39 and 41 upon some triggering event. Examples of a triggering event are the deployment of the tail-hook (by the actuator 8), the deployment of the landing gear, upon the detection of a load or strain encountered by the tail-hook, the detection of an increase in pressure in the main landing gear (e.g. FIG. 3b to FIG. 3c) or the detection of a deceleration by one or more accelerometers 29, 31, 39, 41.

Measurements from tail-hook sensors 14 and 16 are recorded, as are the measurements of the accelerometers 29, 31, 39, 41, as are the measurements from the pressure sensors 19 on the landing gear. An example of measurements of the tail-hook sensor 14 and 16 are shown in FIG. 7. Examples of measurements from the accelerometers are shown in FIGS. 6a and 6b. An example of measurement of the pressure sensors are shown in FIGS. 3a-3f. The measurements are recorded in memory with respect to elapsed time.

The recorded measurements can be accessed and downloaded by way of an input/output port on the computer 43 (FIG. 8). Accessing the measurements can be by a cable or wire to a remote device, such as a remote computer. The remote computer can communicate with and access the data in the memory. Alternative, the measurements can be accessed by way of a wireless communication link.

Once the recorded measurements are downloaded, they are stored and analyzed. Aircraft are designed and built with assumed loads, with the aircraft capable of making a number of landings. The number of landings (and takeoffs) are factors in determining the expected usable life of an aircraft. If the actual landing loads exerted on the aircraft exceed the original design assumptions, being the “fatigue-life assumptions”, then the actual usable life is shortened from the design assumptions or expected usable life. Conversely, if the actual landing loads exerted on the aircraft are below the original design assumptions, then the actual usable life is increased from the design or expected usable life. The measure of load information is analyzed to determine if the aircraft experiences normal, or expected, landing loads, below normal landing loads or higher than normal landing loads. If the actual landing loads are higher than normal, then operations officers may take steps, or change procedures, to lower the actual landing loads encountered in future landing operations of the aircraft.

A carrier-type landing subjects the aircraft not only to vertical loads as the aircraft touches down on the deck, but also horizontal loads as the tail-hook snags the arresting cable. The method and apparatus disclosed herein separately measure the vertical loads and the horizontal loads. The vertical loads are primarily measured by the landing gear pressure sensors 19 and accelerometers 29, 31, 39 and 41, while the horizontal loads are primarily measured by the tail-hook sensors 14 and 16, and accelerometers 29, 31, 39 and 41.

In addition, asymmetrical landings can be identified as the loads on the individual landing gear and wings are different. Thus, a history of asymmetrical landings can be recorded and maintained. Asymmetrical landings are typically undesirable because all of the landing loads are born by one, not both, of the landing gear for a period of time. Asymmetrical landings are identified by differences in the measurements taken by the landing gear pressure sensors 19 and by differences in the measurements taken by the wing accelerometers 29, 31, 39, 41.

Although plural load cell pins 14 have been described as measuring the load or strain the tail-hook exerts on the airframe, other sensors can be used. For example the tail-hook arm can be equipped with a sensor, such as a strain gauge.

Although an exemplary embodiment of the invention has been disclosed and discussed, it will be understood that other applications of the invention are possible and that the embodiment disclosed may be subject to various changes, modifications, and substitutions without necessarily departing from the spirit and scope of the invention.

1. An apparatus for monitoring an aircraft during an aircraft carrier-type landing event, having an arresting cable, comprising:
a) a tail-hook assembly comprising a tail-hook and a mounting assembly, the tail-hook coupled to the aircraft by way of the mounting assembly;
b) a sensor measuring the load applied by the tail-hook to the aircraft;
c) a processor having an input connected to the sensor, the processor having memory and stores sensor measurements therein, the processor recording sensor measurements over elapsed time.

2. The apparatus of claim 1 wherein the sensor is located in the mounting assembly.

3. The apparatus of claim 2 wherein the mounting assembly has a coupling that rotates about a pin, the sensor being located in the pin.

4. The apparatus of claim 1 wherein the sensor is located on a surface of the tail-hook.

5. The apparatus of claim 4 wherein the tail-hook comprises an arm, the sensor located on a surface of the arm.

6. The apparatus of claim 1 further comprising:
a) an inboard accelerometer and an outboard accelerometer located on each wing of the aircraft, with the respective inboard accelerometer located in a portion of the respective wing that attaches to the fuselage of the aircraft and the respective outboard accelerometer located in a respective tip portion of the respective wing;
b) the accelerometers provide inputs to the processor and the processor stores measurements from the accelerometers over elapsed time during a landing event.

7. The apparatus of claim 6 wherein the aircraft comprises landing gear, further comprising:
a) a pressure sensor on each landing gear of the aircraft, the pressure sensors providing inputs to the processor;
b) the processor storing measurements from the pressure sensors over elapsed time during a landing event.

8. The apparatus of claim 1 wherein the aircraft comprises landing gear, further comprising:
a) a pressure sensor on each landing gear of the aircraft, the pressure sensors providing inputs to the processor;
b) the processor storing measurements from the pressure sensors over elapsed time during a landing event.

9. The apparatus of claim 1 wherein the processor further comprises a triggering input, which triggering input initiates the processor to record sensor measurements.

10. A method of monitoring an aircraft during aircraft carrier-type landing events, using an arresting cable, comprising the steps of:
a) providing a tail-hook coupled to a frame of the aircraft;
b) measuring the load the tail-hook applies to the aircraft frame over elapsed time as the aircraft lands;
c) storing the measured loads for subsequent retrieval.

11. The method of claim 10 wherein the step of measuring the load the tail-hook applies to the aircraft frame further comprises the step of measuring the load by way of a mounting assembly that couples the tail-hook to the aircraft frame.

12. The method of claim 10 wherein the step of measuring the load the tail-hook applies to the aircraft frame further comprises the step of measuring the load by way of measuring the stretch of the tail-hook.

13. The method of claim 10 wherein the step of measuring the load the tail-hook applies to the aircraft frame begins with a triggering event.

14. The method of claim 13 wherein the triggering event comprises deployment of the landing gear from a stowed position.

15. The method of claim 10 further comprising the steps of:
a) providing assumed aircraft landing loads;
b) comparing the measured loads over plural landing events with assumed loads.

16. The method of claim 10 further comprising the steps of:
a) providing at least one accelerometer in each one of the wings of the aircraft;
b) measuring the acceleration of the respective wings with the accelerometers and storing the measured accelerations for subsequent retrieval.

17. The method of claim 16 further comprising the steps of:
a) providing a pressure sensor on each landing gear on the aircraft, which pressure sensor measures the internal pressure of the landing gear;
b) measuring and storing the pressure of the landing gear over elapsed time as the aircraft lands.

18. The method of claim 10 further comprising the steps of:
a) providing a pressure sensor on each landing gear on the aircraft, which pressure sensor measures the internal pressure of the landing gear;
b) measuring and storing the pressure of the landing gear over elapsed time as the aircraft lands.
